(19) United States
(12) Patent Application Publication
(10) Pub. No.: US 2011/0206854 A1
(43) Pub. Date: Aug. 25, 2011

(54) Pack of lubricant wipes

(76) Inventor: James Aiden O'Brien, C. Cork (IE)

(21) Appl. No.: 12/998,556

(22) PCT Filed: Nov. 4, 2009
(86) PCT No.: PCT/IB2009/007341

§ 371 Date: May 2, 2011

(30) Foreign Application Priority Data
Nov. 11, 2008 (GB) 0820630.2

(51) Int. Cl. B65D 81/24; B05D 1/28

(52) U.S. Cl. 427/429; 206/205

(57) ABSTRACT

A pack (2) of wipes (4) comprising a container (6) for the wipes (4), and a plurality of the wipes (4) in the container (6), and the wipes (4) being such that they are impregnated with a lubricant. A method of lubricating a product using the pack (2) of wipes (4) is also disclosed.

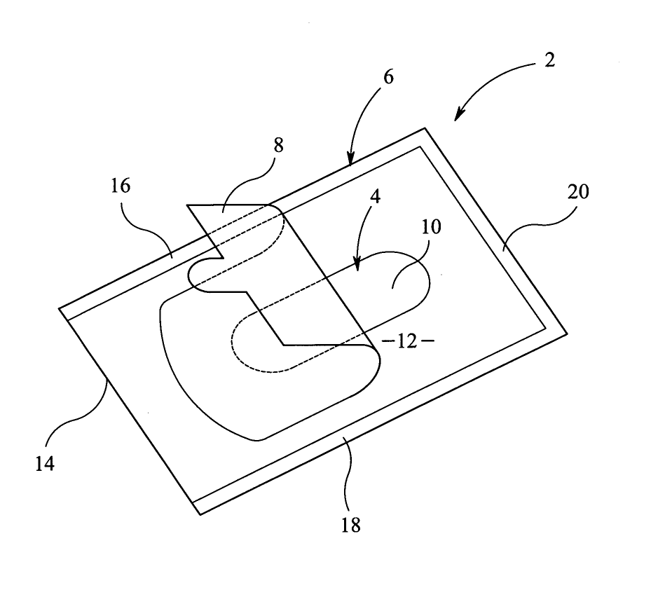

This invention relates to a pack of wipes.

In industry, it is often necessary to draw a cable through a conduit in a building. The cable may be required for wide variety of purposes including carrying electrical power, data or general telecommunications information. The cable is often of a considerable length and friction between the cable and the conduit often makes it difficult to draw the cable through the conduit. Persons installing such cables will normally lubricate the cable in order to facilitate the drawing of the cable through the conduit. An installer will usually carry a bottle of a liquid or gel lubricant. It is often not convenient for the person to carry the bottle of lubricant. Also it is often messy for one person to apply the lubricant from the bottle to the cable since the bottle is usually not such as to facilitate handling of the lubricant and/or dispensation of the lubricant whilst also handling the cable feed.

It is an aim of present invention to reduce the above mentioned problem.

Accordingly, in one non-limiting embodiment of the present invention, there is provided a pack of wipes comprising a container for the wipes, and a plurality of the wipes in the container, and the wipes being such that they are impregnated with a lubricant.

The pack of wipes of the present invention is advantageous in that the container may be constructed to allow easy removal of the wipes from the container. Once removed, the wipes can easily be wiped over the cable to provide the cable with the required lubrication to enable the cable to be drawn into the conduit. Thus the application of the lubricant is easier and less messy than the above mentioned method of applying the lubricant from a bottle of the lubricant. In addition, the wipes enable less of the lubricant to be utilised per application since the wipes are already impregnated with the lubricant, and lubricant does not have to be dispensed from the bottle such that too much lubricant may often be dispensed. In addition to the pack of wipes of the present invention being suitable for lubricating cables, the pack of wipes of the present invention may be utilised for providing any other suitable and appropriate type of product with a lubricant as required.

The pack of wipes of the present invention is thus advantageous in that it is able to overcome the above mentioned existing problem of lubricating cables. The pack of wipes of the present invention is also advantageous in that the wipes can conveniently be used for lubricating other products that might require lubricating. The pack of wipes of the present invention is further such that it is surprising insofar as packs of wipes have been known for many years, with the known wipes being impregnated with a solvent or detergent. These known packs of wipes may employ an aggressive solvent for industrial use where grease, oils and tars need to be removed, or may employ a mild solvent or detergent for use in cosmetic applications by persons wishing to remove make-up or general facial and hand grime, or may employ a detergent for use in hand or surface cleaning.

The present invention is thus in a first area where the above mentioned problem of lubricating cables has been known and has existed for many years. The present invention is also in a second area where packs of wipes have been known for many years but only wipes impregnated with a solvent or detergent and never wipes impregnated with a lubricant. In spite of these two areas having existed for a very long time, no one has previously thought of modifying an existing pack of wipes to replace the solvent or detergent with a lubricant, and thereby to be able to solve the long standing problem of easily and conveniently lubricating products such for example as cables needing to be drawn through ducts.

The pack of wipes of the present invention may be one in which the lubricant is a liquid lubricant or a gel lubricant. The lubricant may be an oil or an oil-based formulation.

The lubricant may be a formulation comprising base oil, usually in a proportion of at least 80% by volume, and one or more enhancing additives, usually up to 20% by volume, to improve one or more of lubrication properties, lubricant adhesions, wear resistance, temperature resistance, shear resistance, friction reduction, viscosity, and shelf life. The base oil may be a mineral oil, a liquid paraffin, a polyglycol, a vegetable oil, a polyalfaolefin, a polybutene, cetylalcohol, glycerine, or blends of these products. Variations may be used to take account of chemical compatibility, operating temperatures, biodegradability, stability, and ecology considerations. The enhancing additives may be one or more of silicone oils, vegetable oil esters, polyfluorocarbons, oleo-chemical derivatives, polyalfaolefins, polybutenes, polyglycols, preservatives, thickeners, and viscosity modifiers, depending on the performance properties desired.

The container may be a flat container. The flat container may be a flat bag.

Usually, the container will be a resealable container. The resealable container may comprise a peel-back adhesive cover which covers an opening in the container and through which the wipes are obtainable, and the peel-back adhesive cover being resealable on the container to reseal the container after the removal of a desired number of wipes through the opening. The wipes may be obtained through the opening and used one at a time or more than one at a time as may be desired.

The container may be made of a plastics material and/or a laminate foil material. The laminate foil material may be an aluminium foil.

The present invention also provides a method of lubricating a product, which method comprises providing a pack of wipes of the invention, removing at least one of the wipes from the pack of wipes, and wiping the wipe on the product in order to lubricate the product with the lubricant that is on the wipe.

In the method of the present invention, the product is preferable a cable which is to be drawn through a conduit. As indicated above however, the method may be used with any suitable product requiring lubrication. Where the product is a cable, then the cable may be a power cable, a data cable, or a telecommunications cable. The cable may be a metal cable or a fibre optic cable.

In the method of the invention, the cable will usually be lubricated in a building, or in a service conduit transporting one or more cables to a building or buildings. The cable may be lubricated elsewhere if desired.

The method of the invention may comprise holding a wipe, and drawing the cable through the wipe while pulling or pushing the cable into the conduit so that the cable is lubricated as the cable enters the conduit.

An embodiment of the invention will now be described solely by way of example and with reference to the accompanying drawing which shows a pack of wipes of the present invention.

Referring to the drawing, there is shown a pack 2 of wipes 4. The pack 2 comprises a container 6 for the wipes 4, and a plurality of the wipes 4 in the container 6. The wipes 4 are such that they are impregnated with a lubricant. The lubricant is a liquid or gel lubricant.

The container 6 is a flat container in the form of a flat bag as shown. The container 6 is resealable by virtue of having a peel-back adhesive cover 8 which covers an opening 10 in the container 6. The wipes 4 are obtainable through the opening 10. The cover 8 is resealable on an upper surface 12 of the container 6 in order to reseal the container 6 after the removal of a desired number of wipes 4 through the opening 10.

The container 6 is made of a plastics material, or laminate foil, or a combination of both. The container 6 may be formed by folding a length of material at a fold line 14, and then sealing the length of material along edges 16, 18, 20. The sealed edges 16, 18, 20 may be formed using heat sealing, ultrasonic welding, or appropriate adhesives.

If the pack 2 is to be used for the purpose of lubricating a product in the form of a cable, then it is simply necessary to remove at least one of the wipes 4 from the pack 2 through the opening 10, and then to wipe the wipe 4 on the cable in order to lubricate the cable with the lubricant that is on the wipe 4.

The pack 2 is convenient to carry. The wipes 4 are provided with predetermined quantities of lubricant. The wipes 4 are easy to remove from the container 6. The lubricant is easily applied to the product such for example as the cable. Wastage of the lubricant as would occur if the lubricant were being removed from a bottle is avoided. Mess created by lubricant being obtained from the bottle and missing the container is also avoided. An important benefit of the invention is the ability to prevent spillage of lubricant from bottles on a site which would cause a potential health and safety risk. A further important benefit of the invention is that one person can manage the lubrication and installation of a cable by pushing the cable into a duct with one hand whilst holding the lubricant wipe at the conduit entry with the other hand. This eliminates the need for a second person.

It is to be appreciated that the embodiment of the invention described above with reference to the accompanying drawing has been given by way of example only and that modifications may be effected. Thus, for example, the container 6 may be in the form of a tub with a press-on or screw lid rather than a flat bag. The lubricant may be selected from a wide variety of lubricants. Other ingredients may be added to the lubricant, for example an anti-rust ingredient.

1. A pack of wipes comprising a container for the wipes, and a plurality of the wipes in the container, and the wipes being such that they are impregnated with a lubricant.

2. A pack of wipes according to claim 1 in which the lubricant is a liquid lubricant or a gel lubricant.

3. A pack of wipes according to claim 1 in which the lubricant is a formulation comprising a base oil and one or more enhancing additives.

4. A pack of wipes according to claim 3 in which the formulation comprises at least 80% by volume of the base oil, and up to 20% by volume of the said one or more enhancing additives.

5. A pack of wipes according to claim 1 in which the container is a flat container.

6. A pack of wipes according to claim 5 in which the flat container is a flat bag.

7. A pack of wipes according to claim 1 in which the container is a resealable container.

8. A pack of wipes according to claim 7 in which the resealable container comprises a peel-back adhesive cover which covers an opening in the container and through which the wipes are obtainable, and the peel-back adhesive cover being resealable on the container to reseal the container after the removal of a desired number of wipes through the opening.

9. A pack of wipes according to claim 1 in which the container is made of a plastics material and/or a laminate foil material.

10. (canceled)

11. A method of lubricating a product, which method comprises providing a pack of wipes according to any one of the preceding claims, removing at least one of the wipes from the pack of wipes, and wiping the wipe on the product in order to lubricate the product with the lubricant that is on the wipe.

12. A method according to claim 11 in which the product is a cable which is to be drawn through a conduit.

13. A method according to claim 11 in which the cable is a power cable, a data cable, or a telecommunications cable.

14. A method according to claim 12 in which the conduit is in a building or in a service conduit transporting one or more cables to a building or buildings.

15. A method according to claim 12 and comprising a wipe, and drawing the cable through the wipe while pulling or pushing the cable into the conduit so that the cable is lubricated as the cable enters the conduit.
